(19) United States
(12) Patent Application Publication
(10) Pub. No.: US 2012/0319489 A1
(43) Pub. Date: Dec. 20, 2012

(54) Power Shuffling Solar String Equalization System

(76) Inventors: Shawn R. McCaslin, Austin, TX (US); Bertrand J. Williams, Austin, TX (US)

(21) Appl. No.: 13/492,084

(22) Filed: Jun. 8, 2012

Related U.S. Application Data
(60) Provisional application No. 61/497,184, filed on Jun. 15, 2011.

(51) Int. Cl. H02J 1/00

(52) U.S. Cl. 307/77

(57) ABSTRACT

A photovoltaic (PV) array system may include multiple PV strings, each PV string including respective PV panels coupled in series. Each PV string may be coupled in series with a first terminal of a respective string equalizer module. The string equalizer module may equalize a maximum power-point voltage (V_{MP}) of the PV string before the PV strings combine to produce a single, composite DC bus voltage on a DC bus. To accomplish this, each string equalizer module may generate a respective adaptive string equalizer output voltage at its first terminal to tune a respective PV string voltage of its corresponding respective PV string to have the V_{MP} of its corresponding PV string match respective V_{MP}'s of other PV strings. That is, PV strings may sink or source power from/to other PV strings, to equalize the V_{MP} of each corresponding respective PV string.

### PRIORITY CLAIM

This application claims benefit of priority of U.S. Provisional Application Ser. No. 61/497,184 titled “Power Shuffling Solar String Equalization System”, filed Jun. 15, 2011, and whose inventors are Shawn R. McCaslin and Bertrand J. Williams, and which is hereby incorporated by reference in its entirety as though fully and completely set forth herein.

### BACKGROUND OF THE INVENTION

1. Field of the Invention

This invention relates generally to the field of photovoltaic arrays, and more particularly to the optimization of power among strings of photovoltaic arrays.

2. Description of the Related Art

Photovoltaic arrays (more commonly known and referred to as solar arrays, or PV arrays or PV solar designs) are a linked collection of solar panels, which typically comprise multiple interconnected solar cells. The modularity of solar panels facilitates the configuration of solar (panel) arrays to supply current to a wide variety of different loads. The solar cells convert solar energy into direct current electricity via the photovoltaic effect, in which electrons in the solar cells are transferred between different bands (i.e. from the valence to conduction bands) within the material of the solar cell upon exposure to radiation of sufficient energy, resulting in the buildup of a voltage between two electrodes. The power produced by a single solar panel is rarely sufficient to meet the most common power requirements (e.g. in a home or business setting), which is why the panels are linked together to form an array. Most solar arrays use an inverter to convert the DC power produced by the linked panels into alternating current that can be used to power lights, motors, and other loads.

The various designs proposed and developed for solar arrays typically fall into one of two configurations: a low-voltage configuration (when the required nominal voltage is not that high), and a high-voltage configuration (when a high nominal voltage is required). The first configuration features arrays in which the solar panels are parallel-connected. The second configuration features solar panels first connected in series to obtain the desired high DC voltage, with the individual strings of series-connected panels connected in parallel to allow the system to produce more current. Various problems have been associated with both configurations, with the most prolific array configuration being the high-voltage series-string based configuration. The series-string configuration raises the overall distribution DC-bus voltage level to reduce resistive losses. However, in doing so it increases panel mismatch losses by virtue of the series-string being limited by the weakest panel in the string. In addition, the resultant DC-bus voltage has a significant temperature and load variance that makes inversion from DC to AC more difficult. Consequently, many design efforts have been concentrated on improving the efficiency of the collection of electrical power from the array, by mitigating these non-idealities.

For a given PV panel, there is typically an optimal operating point, which maximizes power production, for a given irradiance condition. This operating point, the “maximum power point” (MPP), is typically defined as the load current and the corresponding operating voltage at which power production is maximized. The MPP can be dependent on cell temperatures, shading, soiling, and aging, all of which may result in an MPP that varies over time. The concept of MPP also applies to strings of panels, or PV panel strings. In other words, series strings of panels may also have a corresponding or associated MPP. However, panel impairments can cause the power curve (i.e., output power versus voltage) to have multiple maxima, i.e. multiple MPPs, and more than one of those maxima may be global maxima.

Since the key objective in PV solar designs is to maximize power production, a standard part of power maximization has been the tracking of the MPP, referred to as “maximum power-point tracking”, or MPPT. Various designs have been proposed and developed for DC/DC (DC-to-DC) converter systems applied to solar arrays, concentrating on the implementation of MPPT, which employs a high efficiency DC/DC converter that presents an optimal electrical load to a solar panel or array, and produces a voltage suitable for the powered load. Oftentimes the DC/DC converters are implemented with a switching regulator in order to provide highly efficient conversion of electrical power by converting voltage and current characteristics. Switching regulators typically employ feedback circuitry to monitor the output voltage and compare it with a reference voltage to maintain the output voltage at a desired level.

Strings of PV panels can be combined in parallel to create solar arrays. The solar arrays may also have an associated or corresponding MPP, which may not be unique. Whether operating panels, strings, and/or arrays, one key goal is to operate as close to the MPP as possible and as much of the time as possible, to maximize power production. This is typically accomplished through the use of adaptive electronics, which continuously adjust the operating point to find and track the MPP (e.g. by performing MPPT, as mentioned above). As also mentioned above, when performed at a panel level within an array, the MPPT may be accomplished through the use of the DC/DC converter systems, or DC optimizers, with the operating point for each panel in an array optimized individually. Neglecting converter inefficiencies, per-panel optimization typically gives the best performance. However, it is also expensive, requiring custom electronics at each panel in an array.

An alternative approach is to decompose the array into individual strings, and operate optimization on each string individually before the results are combined at the array level. This reduces the number of required devices from one-per-panel to one-per-string, but optimizing at a string level normally requires higher power and higher voltage processing. In addition, conversion losses at the higher string power levels produce much more wasted heat, which can be expensive to dissipate.

For at least the reasons cited above, optimization at a panel level has not been widely embraced, due to the cost and concerns about reduced reliability incurred by array-wide deployment. Inverter manufacturers, however, generally recognize and promote the value of string-level optimization. For example, companies such as Danfoss, SMA Solar Technology, and Satcon, offer string-level optimization products, and they promote the increased array power production provided by those products. However, many issues still remain in providing affordable and reliable solutions directed to string-level optimization.

Many other problems and disadvantages of the prior art will become apparent to one skilled in the art after comparing such prior art with the present invention as described herein.

### SUMMARY OF THE INVENTION

In one set of embodiments, a photovoltaic (PV) array system may include multiple PV strings, each PV string made up of PV panels coupled in series. Each PV string may be coupled in series with a corresponding string equalizer module operated to equalize a maximum power-point voltage (V_{MP}) of the PV string before the PV strings combine to produce a single, composite DC bus voltage on a DC bus coupling to an end of the PV string opposite of the end of the PV string coupled in series with the corresponding string equalizer module. The string equalize module may generate an adaptive string equalizer output voltage at the point of connection with the PV string to tune a respective PV string voltage of the PV string to have the V_{MP} match respective V_{MP}'s of other PV strings. In other words, the PV strings may be configured to have lower power PV strings sink power from higher power PV strings, and higher power PV strings source power to lower power PV strings to equalize the V_{MP} of each PV string.

The power required by the PV strings for equalizing their respective V_{MP}'s may be provided by one or more power sources other than the PV strings. The one or more power sources may include the DC bus voltage, an inverter coupled to the DC bus, an external power supply, an external power storage device, and/or a battery. The PV strings may also be operated to move power from one or more PV strings to a power storage medium. In some embodiments, the string equalizer module may include a DC-to-DC buck/boost converter to divert the power from higher power PV strings to lower power PV strings. The string equalizer modules may also be configured together in a string equalizer combiner module placed at a common junction where respective ends of the PV strings intersect.

In one set of embodiments, the string equalizer module may include a first terminal coupled to a PV panel configured at one end of a corresponding respective PV string of the multiple PV strings, a second terminal coupled to a common return node, and a third terminal coupled to a string equalizer bus. Each string equalizer module may be operated to change a respective voltage at its first terminal in a direction opposite of the change of voltage at the first terminal of another one of the string equalizers, in response to the change of voltage at the first terminal of the other string equalizer. In addition, each string equalizer module may include a maximum power point tracking (MPPT) control loop that includes the first terminal of the string equalizer module, and each string equalizer module may further include a voltage regulation loop that includes the second terminal of the string equalizer module. The MPPT control loop may operate outside the voltage regulation loop at a relatively slow rate, to allow voltages and currents in the PV array system to settle in response to probe steps applied as part of MPPT performed by the MPPT control loop.

The string equalizer modules may compensate for differences in respective maximum power point (MPP) voltages between the multiple PV strings. Furthermore, a respective PV panel at one end of each PV string may be coupled to a common DC voltage bus. The PV array system may also include an inverter coupled to the common DC voltage bus to generate an AC voltage from a DC voltage developed on the DC voltage bus, and to perform MPPT on the DC voltage bus. Each string equalizer module may perform MPPT for its corresponding respective PV string independently from the MPPT performed by the inverter.

In one embodiment, a string equalizer module includes a first terminal adapted to couple in series with a corresponding respective PV string of multiple PV strings, where each PV string is built of PV panels coupled in series. The string equalizer may also include first circuitry configured to equalize a maximum power-point voltage (V_{MP}) of the corresponding respective PV string before the PV strings combine to produce a single, composite DC bus voltage on a DC bus. The first circuitry may also generate a respective adaptive string equalizer output voltage at the first terminal to tune a respective PV string voltage of the corresponding respective PV string to have the V_{MP} of the corresponding respective PV string match respective V_{MP}'s of other PV strings. The first circuitry may sink or source power from/to other PV strings, to equalize the V_{MP} of each corresponding respective PV string.

In some embodiments, the first circuitry is designed with a DC-to-DC buck/boost converter that can sink power from the other PV strings (i.e. PV strings other than the one to which the string equalizer with the first circuit in question is connected) when power provided by the corresponding respective PV string (i.e. the PV string to which the string equalizer with the first circuit in question is connected) is lower than the power provided by each of the other PV strings. Similarly, the DC-to-DC buck/boost converter can also source power to any one or more of the other PV strings that provide lower power than the power provided by the corresponding respective PV string. The power required by the PV string equalizer for equalizing its respective V_{MP} may be provided by one or more power sources that do not comprise the plurality of PV strings, and/or any power storage media.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 shows an example diagram of a conventional series-string and parallel branch solar array configuration;

FIG. 2 shows an example of a series-string solar array configuration retrofitted with DC/DC converters attached to the solar panels;

FIG. 3 shows an example of a parallel-string (parallel connected) solar array configuration with DC/DC converters attached to the solar panels;

FIG. 4 shows an example V/I power curve for a series-string solar array configuration;

FIG. 5 shows an example V_{OC} & V_{MP} vs. temperature curve for a typical solar panel;

FIG. 6 shows an example V/I Curve for a typical solar panel at different insolation levels;

FIG. 7 shows an example power vs. Vₒ and V_{BUS} curve representing characteristics of a constant power port;

FIG. 8 shows one embodiment of a DC/DC converter controller that features an inner control loop regulating to V_{I}, and an outer MPPT control loop that sets the value for V_{I};

FIG. 9 shows one embodiment of a configuration in which DC-DC converters are coupled at the bottom of strings of PV panels to operate as string equalizers;

FIG. 10 shows one example of voltage distribution across the configuration shown in FIG. 9 when string-level equalization is performed;

FIG. 11 shows one embodiment of a DC-DC converter operating as a string-level equalizer, with the left port coupled to the bottom of a string of PV panels;

FIG. 12 shows one embodiment of a DC-DC converter operating as a string-level equalizer, with an inverted topology with respect to the embodiment shown in FIG. 11, with the left port coupled to the top of a string of PV panels;

FIG. 13 shows one embodiment of a DC-DC converter operating as a string-level equalizer, with a mirrored topology with respect to the embodiment shown in FIG. 11, with the left port coupled to the top of a string of PV panels; and

FIG. 14 shows one embodiment of a solar array with strings, with bottom of string wiring connectivity, with the top of string wired straight through the combiner.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

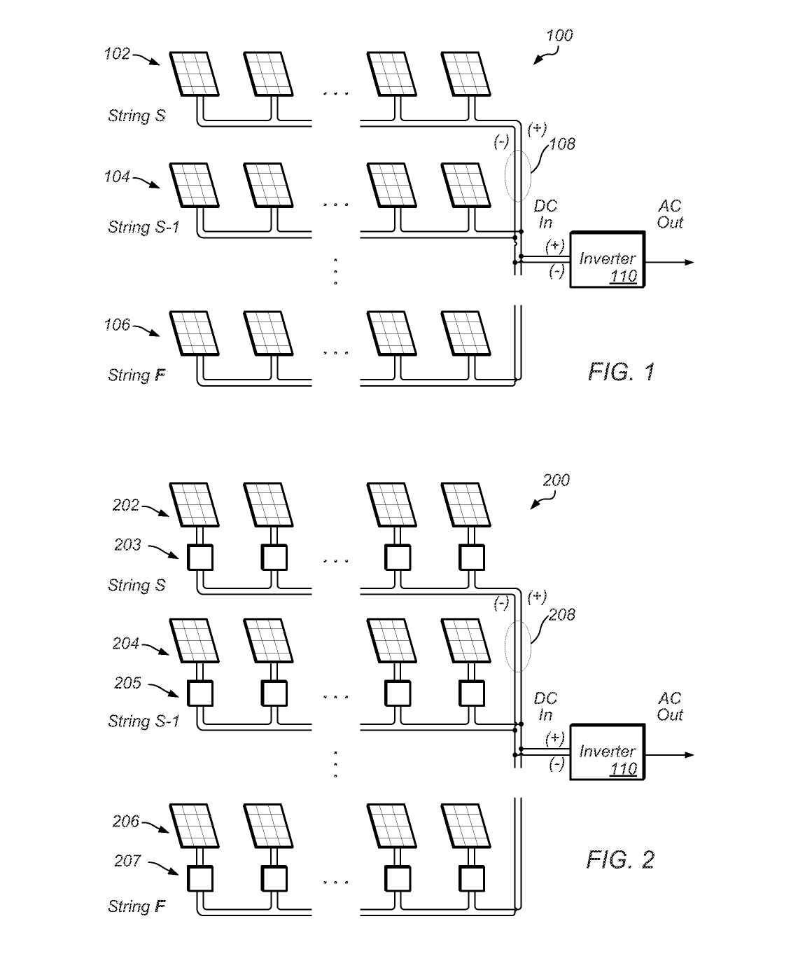

A typical solar array 100 is shown in FIG. 1. Solar panel series-strings 102 (String S), 104 (String S-1), and 106 (String F) are coupled in parallel to bus 108, which may be a DC/DC bus. Each solar panel series-string includes solar panels coupled in series to a respective bus, each of those respective buses coupling to bus 108 as shown to obtain parallel-coupled solar panel series-strings. An inverter 110 is coupled to bus 108 to ultimately drive a connected load, which may be coupled to the output of inverter 110.

An example of the V/I (voltage/current) characteristic for each solar panel is shown in FIG. 4. As seen in FIG. 4, the V/I characteristic may be modeled as a current source in parallel with a multiplied shunt diode, where the current is proportional to the solar insolation levels, and the shunt diode is the result of the solar cell diode in each cell multiplied by the number of cells in series which make up that solar panel. Curve 302 represents the V/I curve, that is, the current I output by the solar panel (represented on the vertical axis) for a given output voltage V (represented on the horizontal axis). Curve 304 represents the power curve associated with V/I curve 302, showing the maximum power point P_{MP}, that is, the point at which the product of the current and voltage output by the solar panel is at its maximum. These values are indicated as I_{MP} and V_{MP}, respectively, and I_{MP}*V_{MP}=P_{MP}. V_{OC} indicates the open circuit voltage output by the solar panel, that is, the voltage output by the solar panel when not providing current to a load. Similarly, I_{SC} indicates the short circuit current output by the solar panel, that is, the current output by the solar panel with its output terminals shorted together. V_{BUS} indicates the total voltage that appears on the bus for N solar panels connected in the series-string.

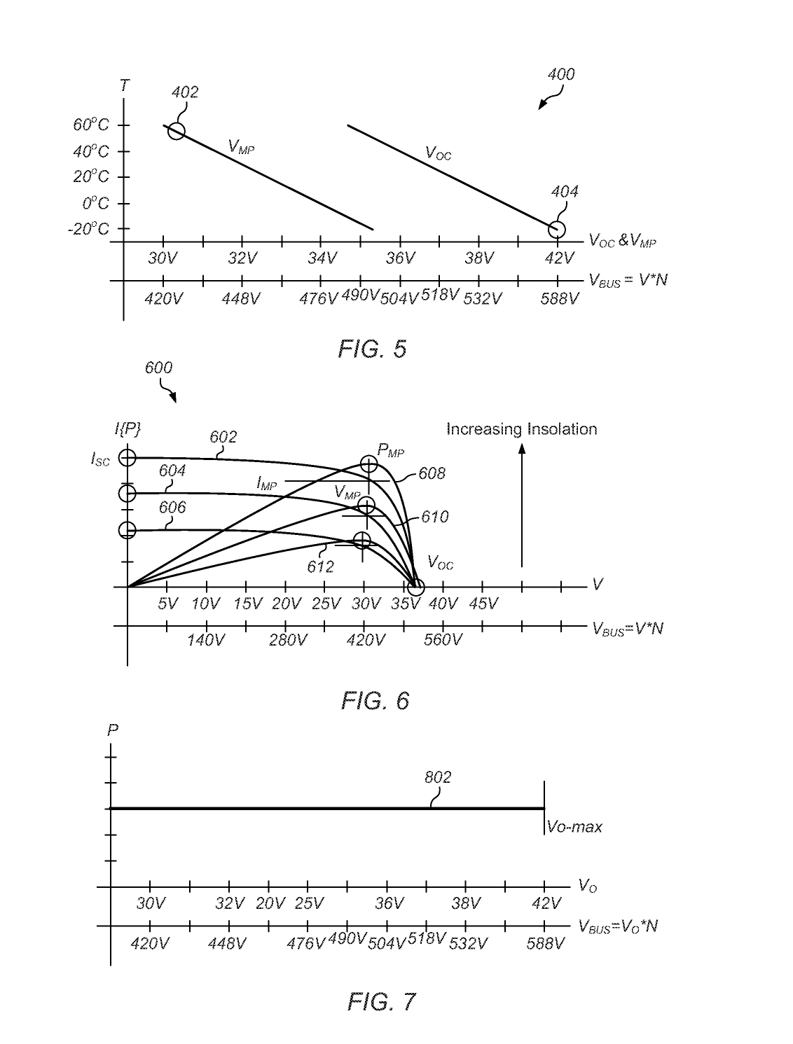

Turning now to FIG. 5, the open circuit voltage V_{OC} of the solar panel may be set by the current—generated as a result of solar insolation—shunted by the series multiplied diode elements. As determined by the shunt diodes within the cell, this voltage may exhibit temperature variance similar to a silicon diode junction. The V_{OC} for a solar panel may thus increase with decreasing temperature, and vice-versa, as indicated by the V_{OC} curve shown in FIG. 5. Consequently, in order for the maximum bus voltage (maximum V_{BUS}) to comply with NEC (National Electrical Code) standards, the number of solar panels that may be connected in series at a given site needs to be determined based on the expected coldest temperature at that site. The bus specification usually limits the maximum value of V_{BUS} to 600V in a US NEC compliant system. It should also be noted that at high temperatures, and while under load, the bus voltage may be substantially lower than the allowed operating level for the Bus. Point 402 on the V_{MP} curve indicates the typical V_{MP} condition, and point 404 on the V_{OC} curve indicates a typical V_{OC} condition.

In solar array systems, many non-idealities may be mitigated by utilizing distributed Maximum Power Point Tracking (MPPT). Distributed MPPT can include the insertion of a DC/DC converter or a similar power converter behind solar panels in the array, oftentimes behind each and every solar panel in the array, to adapt the coupled solar panel's power transfer onto a high-voltage bus (typically a high-voltage DC bus) which connects the panels together via the DC/DC converters. Use of a properly designed respective adaptive DC/DC converter coupled to each solar panel in a solar panel array allows for modification of the curves shown in FIG. 5, under algorithmic control of the DC/DC converters. In order to calculate how many panels may be placed in series, the following equation may be used:

N=Integer(V_{BUS-max}/V_{OC-p}), (1)

where V_{BUS-max} is the maximum value of V_{BUS}, e.g. 600V when observing NEC standards, and V_{OC-p} is the maximum value of V_{OC} for any given panel utilized in the array, at the minimum site location temperature. For example, if V_{BUS-max}=600V, and V_{OC-p}=42V:

N=Integer(600V/42V)=Integer(14.28)=14. (2)

Therefore, 14 panels of this type may normally be placed in series for a cold temperature V_{BUS-OC}=˜14*42V=588V. According to the V/I curve 402, which corresponds to high temperature and operation at the maximum power point, in FIG. 4, V_{MP} at 45° C. is close to 30.5V, resulting in a bus voltage value of V_{BUS}=˜14*30.5V=427V under normal operating conditions for this example.

During normal operation, each panel may therefore contribute ˜32V to the total bus voltage for the solar panel array string under. Assuming a case of shading, damage, or extreme mismatch, which may result in a given percentage of the solar panels in each string not providing normal power, the V_{MP} bus voltage level may decrease by the amount that the given percentage of the solar panels fails to provide. For example, 20% of the solar panels in a given series-string failing to function normally may lead to a normal operating voltage of the series-string of V_{BUS}*˜80%=358V, which represents a substantial drop. If other series-strings (of solar panels) maintain the bus voltage at V_{BUS}=448V under normal conditions, the given series-string may produce no power at all, and may come close to act as a shunt diode load on the high-voltage DC bus (e.g. bus 108 shown in FIG. 1).

In this example, to design a DC/DC converter unit to isolate the panel voltage from the Bus voltage to alleviate the problem, the desired operating points may be specified by determining the number of panels, and thus converter modules, to be connected in series. For V_{BUS-MAX} (i.e. maximum bus voltage) conditions, each converter module may be limited to V_{O-MAX}=600V/14=42.85V, comparable to the panel V_{OC}, that is, V_{OC-p}. Furthermore, each module may be operated sufficiently below this level, to ensure that when a specified percentage (e.g. 15%) of the number of the solar panels are dysfunctional, the remaining modules may successfully boost up their voltage, staying below V_{O-MAX}, to compensate for lost voltage in that string. In the specific example provided, the preferred output operating voltage for each DC/DC converter module may thus be expressed as:

V_{O-nom}≦(12/14*42.85V)≦36.7V, and thus, (3)

V_{BUS}=36.7V*14=513.8V, normally. (4)

More generally, the nominal output voltage for each solar panel may be determined by dividing the number of functioning panels by the total number of panels in the series-string, and multiplying the result by the maximum output voltage of each solar panel. In this example, the bus voltage at the normal operating point may be improved by 15%, reducing the DC bus losses by ˜32%. The resulting system may therefore become tolerant of two panels in each string becoming non-functional, fully or partially, while maintaining power from the other panels. In cases of less than fully non-functional operation, many of the panels may be degraded substantially for the same recovery level.

### Maximum Power Point Tracking:

FIG. 2 shows one embodiment of a system 200 featuring solar panel series-strings 202, 204, and 206, with each of solar panels 202, 204, and 206 coupled to a respective power converter unit of power converter units 203, 205, and 207, respectively. In this case, power converter units 203, 205, and 207 may each include a control unit and a power converter controlled by the control unit, and providing a voltage for the respective bus to which the given string is coupled, with the buses coupling to bus 208 in parallel as shown. Thus, respective outputs of the power converters and controllers 203 are series coupled to high voltage DC bus for String S, the respective outputs of the power converters and controllers 205 are series coupled to high voltage DC bus for String S-1, and the respective outputs of the power converters and controllers 207 are series coupled to high voltage DC bus for String F, with the three buses parallel coupled to high voltage DC bus 208. Inverter 110 may be coupled to bus 208 in system 200, to drive a connected load(s). For the sake of clarity, each power converter and controller will be referred to herein simply as a “converter unit”, with the understanding that each converter unit may include a power converter, e.g. a DC/DC switching converter, and all associated control circuitry/unit, e.g. functional units to perform MPPT. Each of the attached converter units 204 may be designed to execute a control algorithm, which may exercise control over a switching power conversion stage.

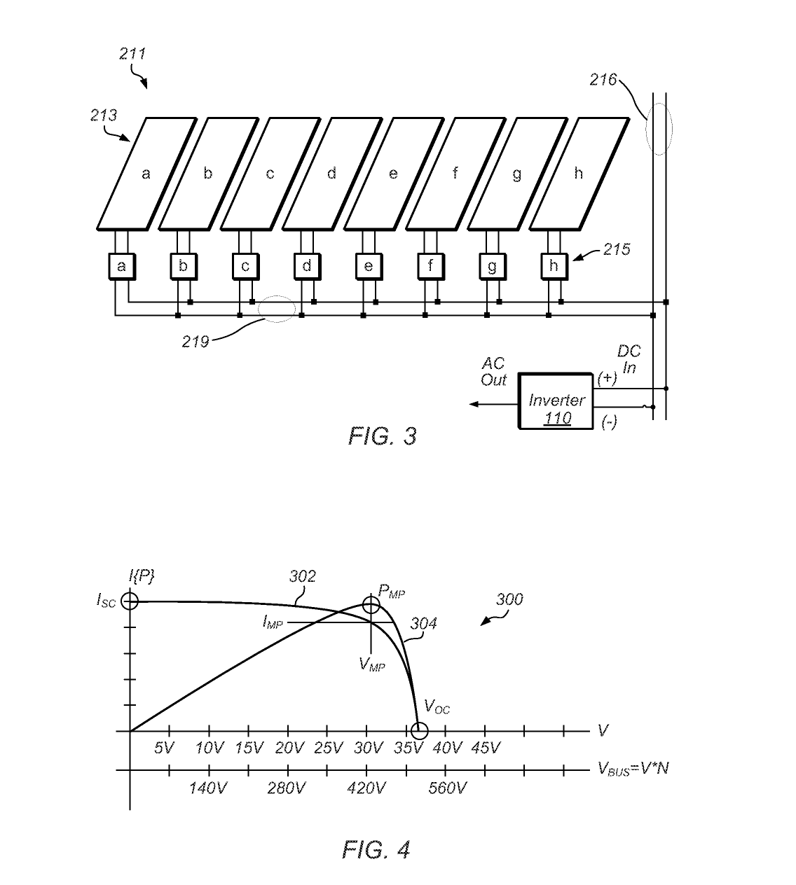

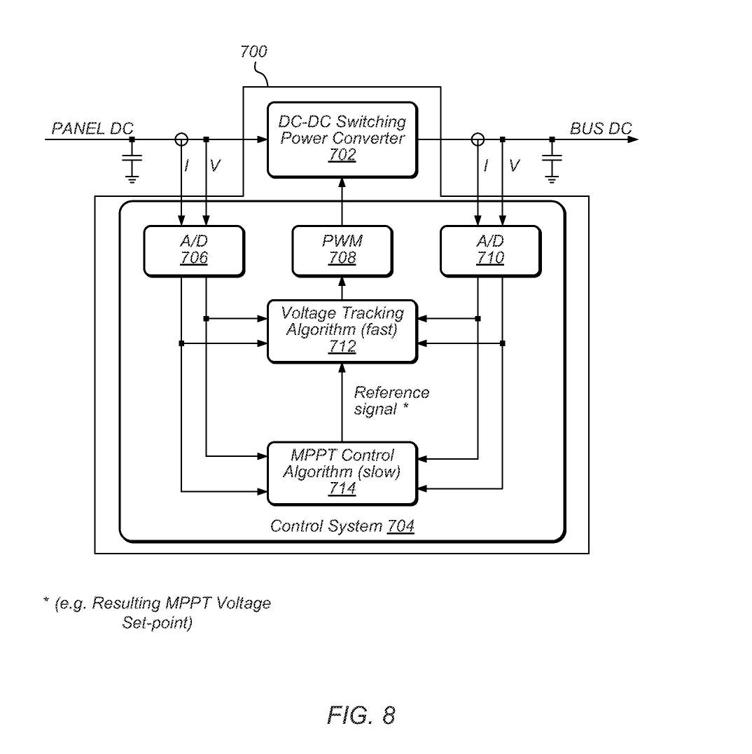

In alternate embodiments, the respective outputs of the power converters and controllers 204 may be parallel coupled to high voltage DC bus 208, which may be coupled to high voltage DC bus 206. FIG. 3 shows one embodiment of a system 211 featuring a solar panel parallel-string 213, in which each of solar panels 213 a-h is coupled to a respective converter unit 215 a-h. Converter units 215 a-h may also each include a control unit and a power converter providing a voltage for bus 219, and controlled by the control unit. For example, panel 213a is coupled to converter unit 215a, panel 213b is coupled to converter unit 215b, and so on. The respective outputs of the power converters and controllers 215 are then parallel coupled to high voltage DC bus 219, which may be coupled to high voltage DC bus 216. Each of the attached converter units 215 may be designed to execute a control algorithm, which may exercise control over a switching power conversion stage. For a more detailed presentation, please refer to U.S. patent application Ser. No. 12/314,050, fully incorporated herein by reference. One possible embodiment of a converter unit 205 is provided FIG. 8. Again, an inverter 110 may be coupled to bus 216 in system 211, to provide AC power to a connected load(s).

Many algorithms currently exist for determining and maintaining MPPT operation in a system such as system 200, including Hill Climbing, Zero Derivative, Fuzzy Logic, etc. While such algorithms are applicable to these systems, each has its own advantages and disadvantages. The choice of algorithm type may be determined by a compromise of dynamic tracking characteristics, precision, and/or tracking bandwidth against desired results. Most algorithms may be considered equivalent of each other and equally applicable to a static system. Dynamic conditions typically occur during variable cloud shading and similar events, where the characteristics of the solar panel connected to the converter unit, as well as all of the other solar panels in the string may be affected rapidly. In one set of embodiments, a novel converter unit may implement a fast algorithm to track the dynamic conditions, and a slow algorithm to maintain accuracy and precision of the MPPT operating point.

Possible responses of the converter unit may be categorized as falling into one of two basic categories: a response to provide accurate MPPT, and a response to meet the needs for fast adaptive tracking. One solution may be derived from the unique characteristics of the solar panel V/I curve during most fast transients. A typical transient under consideration might be a cloud passing over the solar panels, producing a variable insolation level transient.

The graph 600 in FIG. 6 shows V/I curves for a given solar panel under three substantially different insolation levels. V/I curve 602 corresponds to a highest insolation level, V/I curve 604 corresponds to a lower insolation level, and V/I curve 606 corresponds to a lowest insolation level. Power curves 608, 610, and 612 in graph 600 are the power curves corresponding to V/I curves 602-606, respectively. As seen in graph 600, the current I generated by the solar panel is substantially reduced at lower insolation levels. In fact, it is typically the case that the current I is directly proportional to the insolation level. As a result, and as also seen in graph 600, the voltage at which MPPT is achieved remains substantially static, and varies very little over a transient of different insolation levels. In other words, the desired voltage V_{MP} varies minimally, if at all, with respect to changing insolation levels. Consequently, early control systems for solar panels did not include a MPPT mechanism at all, but rather just operated the solar panel at a fixed voltage under all conditions, with the fixed voltage presumed to be near the desired MPPT voltage. However, such systems are not adaptive, and consequently cannot determine what the proper operating voltage for that given panel or string should be. Because of their lack of accuracy, the operation of such systems results in substantially reduced power transfer.

One embodiment of an improved converter unit and method for achieving a fast response time together with accurate MPPT is shown in FIG. 8. Converter unit 700 may include a fast tracking inner control loop, which may be a fast tracking voltage regulating loop 712, and a slower MPPT tracking loop 714 utilized to set the “Reference” point for the inner control loop 712. In the embodiment shown, the Reference point is the reference voltage for the fast tracking inner control loop 712. The Reference point may be provided by MPPT loop 714 in the form of a control signal, whether analog or digital, to the inner voltage regulating loop 712, to determine what reference point (in this case reference voltage) the control system 704 should regulate to. The inner fast tracking loop 712 may directly control the DC/DC conversion duty-cycle of PWM control signal 708 for switching converter 702, and the outer MPPT loop 714 may continually monitor and average the power conditions to instruct the inner loop 712 what voltage value regulation should be performed to. Again, A/D converter 706 may be used to sense and sample the input voltage and current obtained from the solar panel, and A/D converter 710 may be used to sense and sample the voltage and current output by switching converter 702. However, in case of analog implementations, there is no need for A/D converters 706 and 710. Inner control loop 712 may be designed to monitor one or more of the input-ports (I and V received from the solar panel) and output-ports (I and V received from the output of power converter 702). Accordingly, converter unit 700 may include a total of four input ports, a first pair of input ports to receive input-port voltage and current from the solar panel, and a second pair of input ports to receive output-port voltage and current from power converter 702. It may also include an output port to provide the control signal to power converter 702 via PWM 708.

In one embodiment, fast tracking loop 712 may include a hardware PWM controller generating the PWM control signal 708 using analog and digital hardware functions, for a fully hardware-based control system. In another embodiment, fast tracking loop 712 include a microcontroller based system utilizing A/D and PWM peripherals implementing the fast tracking loop as a combination of hardware and firmware. Choices of embodiments including hardware and/or software implementations or a combination thereof may be based upon cost and performance criteria for the intended system while maintaining equivalence from an architectural perspective disclosed in at least FIG. 8.

MPPT algorithms typically use some form of dithering to determine a derivative of the Power vs. Voltage conditions, or to determine and maintain operation at the maximum power point. In converter unit 700, this dithering may now be performed by control system 704 dithering the reference signal (e.g. the resulting MPPT set-point, which may be an MPPT voltage set-point for regulating the input-port voltage, that is, the voltage input to A/D 706 and into converter 702) to the inner loop 712, rather than by directly modulating the duty-cycle of PWM signal 708. The advantages of the dual-loop structure in converter unit 700 include improved stability of the system, and very fast acquisition and tracking of the system during transients. Other advantages that may also be derived from the architectural partitioning into two control loops include current-mode operation of the inner Vin regulating control system, that is, current-mode operation of the inner control loop 712. Current-mode operation offers several advantages, including excellent tradeoff between stability and tracking speed, over-current protection and limiting, and automatic pulse-skipping during discontinuous-mode operation. Current-mode operation of fast tracking inner loop 712 may be particularly attractive, and easily enabled, when fast tracking inner loop 712 is implemented fully in hardware.

Since the efficiency of a power converter is related to the losses in the system compared to the power transferred through the system, it may be advantageous to reduce the losses for a given power level. Losses for a DC/DC converter can typically be lumped into several categories: transistor switching losses, transistor and diode resistive losses, core losses in the magnetics, resistive losses in the magnetics, control power used, and other miscellaneous resistive losses, including current sensing, etc.

In applications where the system is designed for high power levels, and the power is substantially reduced as a result of certain conditions, transistor switching losses may oftentimes become substantially dominant at the reduced, lower power levels. The control algorithm for the PWM controller may be modified to adjust the switching rate or timing at lower power levels to accommodate these conditions. By separating the input voltage regulating loop 712 from the MPPT loop 714, more complex PWM control may be introduced into the design of the inner loop 712. Because regulation in MPPT is in effect performed for optimizing power (specifically finding the maximum power point), a single loop may not be able to easily integrate dependent functions such as dynamic pulse skipping based on current. While it may be possible to implement such functionality in a single loop, it may prove overly difficult to do so, and the complexity and computational burden on microcontroller firmware may have to be substantially increased. Use of certain analog current-mode controllers for implementation of the inner voltage regulation loop 712 may allow natural implementation of low power pulse skipping for properly constructed designs.

DC/DC converter 702 may be designed to take advantage of the fact that the PWM duty-cycle is proportional to the power being transferred in the general case, and as the PWM duty-cycle drops below a predetermined level the on-time of the power output stage of converter 702 may be held constant while the off-time is increased, effectively reducing the switching rate and the related transistor switching losses. In addition, since below a certain lower predetermined duty-cycle value it may no longer be necessary or desirable to hold the on-time constant while decreasing the off-time, the rate may then be held and the duty-cycle again returned to conventional operation down to approaching 0%. This hybrid mode operation allows for optimization of the losses over a much broader range of power levels, especially in the crucial range where the input power is lower than normal. This feature may be implemented as a firmware controlled feature, or it may be implemented directly within analog and/or mixed-signal hardware peripherals to the microcontroller, or it may be implemented based upon a conventional analog current-mode architecture. Furthermore, when the power converters coupled to the solar panels are connected in parallel (e.g. refer to FIG. 3, and U.S. patent application Ser. No. 12/314,050, fully incorporated herein by reference), fast tracking inner loop may be operated to adjust the output voltage of power converter 702 based on the Reference signal, as opposed to adjusting the input voltage of power converter 702.

In one set of embodiments, a DC/DC switching power converter, such as converter 702, for example), may utilize pulse-based switching of devices connected to magnetic and capacitive elements to create a well controlled power transfer characteristic. The pulse timing may completely determine these transfer characteristics. In general DC/DC converters may be operated as constant-power-transfer devices, where Pₒᵤₜ=Pᵢₙ, (i.e. the output power equals the input power), minus the switching losses and/or other losses incurred in the converter. When a converter is configured to manage the input port, as MPPT-based converter 700 may be configured, the output port power tracks the input port power, and the pulse-timing (of the PWM 708, for example) may be adjusted to adapt to the required conditions at the input port and at the output port for transferring power to the load. This process may create a condition on the output port that causes the output port to operate as a “Virtual Power Port”, or “Constant Power Port”. In effect, no matter what voltage is established or impressed upon the output port, the power may be the same, as shown in the power vs. voltage diagram in FIG. 7. As indicated in FIG. 7, the power curve 802 may remain constant over output voltage and bus voltage variations, when operating the DC/DC switching converter according to an MPPT algorithm. In other words, the internal pulse-timing may be adjusted to produce the flat power curve 802 seen in FIG. 7.

### String-Level Equalization

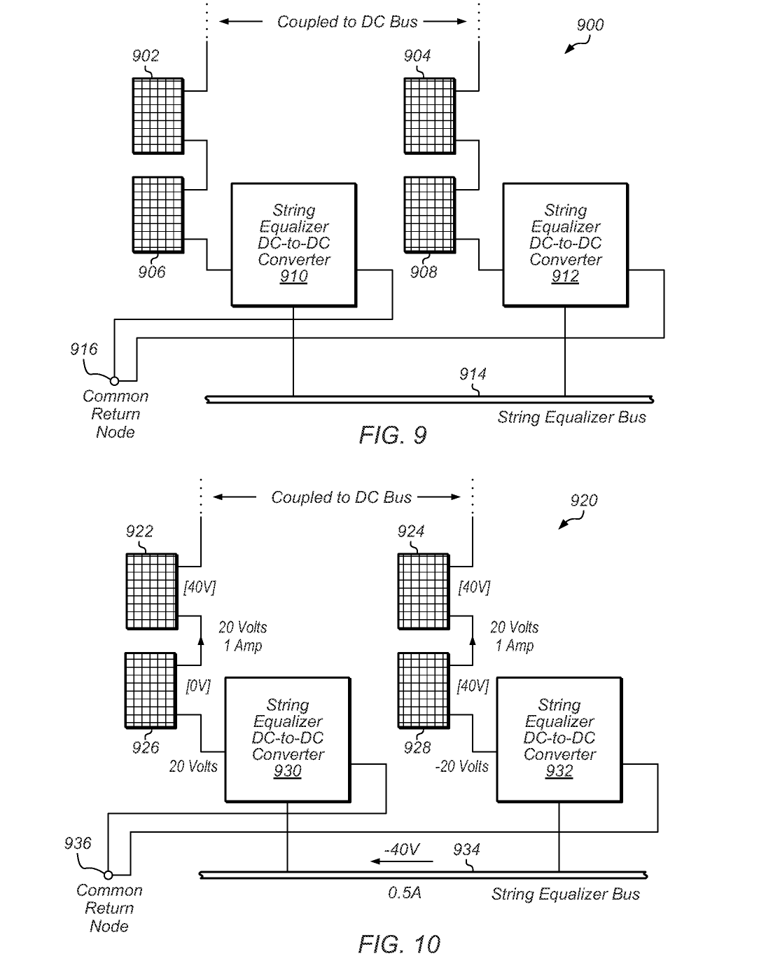

As previously mentioned, a PV array may be decomposed into individual strings, and optimization may be performed for each string individually before combining the results at the array level. While this reduces the number of required devices to one device per string, optimizing at a string level normally requires higher power and higher voltage processing, leading to conversion losses at the higher string power levels producing excess heat that can be expensive to dissipate. It would therefore be advantageous to have a means for providing PV string-level optimization as opposed to PV panel-level optimization, without having to operate at PV string power and voltage levels. To accomplish this, an electronic device may be added in series in each PV string to provide ‘PV string equalization’. In other words, devices may be added to equalize the V_{MP}'s (maximum power-point voltages) of the PV strings in an array before the PV strings are combined to form a single, composite DC bus, that is, before the PV strings combine to produce a single, composite DC bus voltage on a DC bus. The device, referred to hereinafter as “string equalizer” may generate an adaptive output voltage that may tune the PV string voltage of its corresponding PV string (that is, the PV string to which the string equalizer is attached for the purpose of equalizing that PV string's voltage) to have its V_{MP} match the V_{MP} of the other PV strings in the array. Accordingly, when the inverter adjusts the DC bus voltage to find the MPP of the array, it may also thereby find the MPP of each PV string in the array. Example of PV systems employing string equalizers are shown in FIGS. 9 and 10 and will be discussed in more detail further below.

It should be noted that adding voltage to a PV string requires adding power. For example, for a PV string current of 1 A, adding 10V requires adding 10 W to that PV string. Therefore, in one set of embodiments, the PV string system may be configured to have weaker PV strings sink power from stronger PV strings as required, to equalize the V_{MP}'s of the PV strings in an array, as shown in FIG. 10, which will also be discussed in further detail below. It should also be noted that the power required by PV strings for string equalization may alternatively come from other sources, such as from the DC bus, from the inverter connected to the DC bus, from an external power supply, or from any one or more alternative power sources. However, it may be preferable to have PV strings draw current from each other, to produce an efficient and inexpensive solution.

In one set of embodiments, DC-DC buck/boost converter technology may be used in the string equalizer devices to divert power from strong PV strings into weak PV strings. This may include bridging PV strings with DC-DC converters, preferably at the top(s) of PV strings and/or at the bottom(s) of PV strings, to minimize the operating voltage range of the converters. Another potential advantage to having the string equalizer (e.g. a device using the DC-DC buck/boost converter technology adapted to divert power between PV strings) placed at the ends of the PV strings is that it allows for the placement of the string equalizers into a PV string combiner module, or in an adjacent dedicated module, instead of placing the equalizers out in the array, attached to PV panels. This may potentially reduce the cost of the system, and simplify installation and maintenance, especially for retrofitting existing applications, and even for test installations or speculative installations.

Having string equalizers combined in combiner modules (e.g. physical ‘boxes’) also makes it easier to provide power to the string equalizers for control operation. The power provided to the string equalizers may come from an external power supply as opposed to originating from the PV strings themselves, for example. Providing control power from an external supply allows the control operation to be performed reliably, even in arbitrarily low irradiance conditions. For example, operations such as firmware updates may be performed at night. In such cases, the power supplies may have a ‘floating reference’, meaning that they may be isolated or AC coupled to the modules.

Deployment at the bottom portion of PV strings may be particularly advantageous, since any wires that are to be connected between string equalizers may operate at very low voltages relative to ground, minimizing the potential for arc faults to ground, and also minimizing the potential for high voltages in the electronics. Having string equalizers both at the top of PV strings (top portion) and bottom of PV strings (bottom portion) of PV strings may also be advantageous, since the dynamic range of equalization for a PV string may be potentially doubled, relative to the dynamic range of a single module. Placing the string equalizers at the ends of PV strings may also provide the advantage of making the design of extremely fail-safe string equalizer modules fairly straightforward. For example, the string equalizers may be designed to default to a pass-through mode in the event of a complete loss of control power and operation, which may simply result in the array reverting to normal, unequalized operation. Should a PV string-level optimizer fail, power corresponding to at least one PV string may likely be lost. This feature may also be useful in evaluating the power gain provided by the string equalizers. For example, all string equalizers may power down or power up upon receiving a specified command instructing the string equalizers to do so, enabling a contrast between unequalized and equalized operation on array power production.

Yet another advantage of placing string equalizers at the ends of PV strings is that the string equalizers may be designed to provide protection against reverse current flow into PV strings when the inverter (e.g. inverter 110 in FIGS. 1-3) connected to the DC bus is turned off. Normally, with conventional PV arrays, asymmetries between PV strings may cause currents to flow from strong PV strings into weak PV strings, potentially damaging weak PV strings. In order to prevent reverse current flow, installers sometimes add PV string diodes, which block reverse currents at added cost and parasitic power loss. With equalized PV strings, reverse currents may be blocked without the need to install and operate PV string diodes.

One implied assumption with this approach is that the control voltage range required for equalization is a small fraction of the PV string voltage (and smaller than the voltage range normally provided by true PV string-level optimization). This allows a string equalizer to manage a small fraction of the power in the PV string, since the adjusted power is the product of the overall string current and adjusted voltage (I_{string}*V_{Adjusted}=P_{Adjusted}), allowing the string equalizer to greatly improve the effective string equalizer efficiency. For example, if the string equalizer can only adjust the PV string V_{MP} by 10% of the total PV string voltage, then the string equalizer's effective efficiency losses would be at one tenth of what they would be for an equivalent PV string-level optimizer that manages all of the PV string power, since the string equalizer may be processing only 10% of the power of the PV string. Furthermore, the string equalizers may be largely indifferent to the number of panels in a PV string as they may not require access to both ends of a PV string, and would therefore not be exposed to the full PV string voltage. For a given control-voltage range, the range may decrease as a percentage of the total length as the number of PV panels in a PV string increases. As a result, the number of impaired PV panels for which a string equalizer may compensate in a PV string may decrease as the PV string length increases, while the compensation as a percentage of power may be maintained.

Another potential advantage of PV string equalizers is their capacity for providing PV string-current monitoring, useful for isolating power-production anomalies in an array down to a particular PV string. Weak PV string currents may be indicative of defects in one or more panels situated in associated/corresponding PV strings. Therefore, different variations/types of string equalizer devices are possible and are contemplated, including one type which may provide only monitoring, another type which may provide only equalization, and yet another type that may provide both monitoring and equalization functionality. If all of the string equalizer devices are deployed together in boxes/modules near the inverter, it may be particularly convenient to provide wired or wireless telemetry links to those boxes/modules. It should be noted that with wired telemetry, electrical power for string equalizer control operation may also be potentially provided over the telemetry cables.

A string equalizer's output voltage may also be used for providing diagnostic information. For example, when a voltage that would normally be provided by a PV panel substring is instead provided by a particular string equalizer, it may be an indication of a PV substring in one panel in that string equalizer's PV string having failed. This provides an important advantage over monitoring only string-level current, since currents in PV strings can also vary for benign reasons, such as different tilt/orientation between PV strings. It should also be noted that weak panels in a PV string may have different V_{MP}'s than other panels in the PV string. Those differences may result in a PV string having multiple power maxima versus the PV string voltage. To maximize array power, the string equalizers may be used to find the true V_{MP} for each PV string. A string equalizer may easily determine whether it is sourcing power to the other string equalizers in its array (i.e. the array to which the string equalizer is attached and for which it is operated), or sinking power from the other string equalizers in its array. A string equalizer that is sinking power may determine that it is connected to a relatively weak PV string, and may subsequently search for alternative operating points to provide higher power than it may be providing at its current operating point.

In some embodiments, the string equalizers may be operated to compensate only for differences between PV strings. The inverter coupled to the DC bus (e.g. inverter 110 shown in FIGS. 1-3) may still be operated to handle changes in array-wide conditions. For example, the inverter may still provide rapid changes in bus-load current to handle rapid changes in array-wide irradiance, and the setpoints of individual string equalizers may not need to be adjusted to accommodate such changes. Changes between PV strings typically develop slowly, therefore a lower tracking bandwidth and lower speed for the string equalizers may be sufficient. The presence and operation of string equalizers may therefore be transparent to the inverter attached to the DC bus, obviating the need for special configurations and/or capabilities for the inverter.

String equalizers may also be used to potentially disable or reduce power production (i.e., current flow) in a PV string on demand, without the addition of a series bypass relay. For example, one or more of the string equalizers may be operated to deliberately pull the PV string off its MPP to reduce or stop power production, and consequently reduce current flow. This may allow PV string wiring to be disconnected for maintenance and isolated panel testing and troubleshooting without having to shut down the entire array first. It may further allow a string equalizer to be removed from a PV string without having to shut down the entire array first. Another variant of this feature is current limiting. For example, when all PV strings in an array are identical, under normal circumstances the string equalizers may not be required to perform any control operations, and PV string currents may be set by the inverter operating on the DC bus. One way to limit current in this case may be to designate each PV string equalizer in the array as either an ‘even’ string equalizer or an ‘odd’ string equalizer, with ‘even’ string equalizers moving the PV string voltage in one direction, and the ‘odd’ string equalizers moving the PV string voltage in the opposite direction. All string equalizers may move their respective PV strings off of their MPPs, but in a way that may not be possible for the inverter. Thus, PV string currents, as well as the aggregated bus current may be reduced or bounded upon command. Overall, a precise current limit setpoint may be achieved by coordinating the string equalizer units.

Current limiting features may be used to limit peak power at the inverter connected to the DC bus, and therefore, enable power over-subscription. Some inverters already have the ability to limit peak power, but string equalizers may likely respond to changes in irradiance much quicker than inverters, and may therefore be more effective in dynamically limiting peak current and power.

### Arc Fault Detection

In one set of embodiments, PV string-level equalizers may also be used in arc-fault detection. In most current systems, detection of series and parallel arc-faults in PV arrays is typically performed on the DC bus. When an arc-fault is detected, the inverter connected to the DC bus is shut down until the fault is isolated and repaired. It is however possible for the arc-fault detector to be tripped erroneously, and erroneous fault reports may result in unnecessary power loss, and may result in a repair truck being unnecessarily dispatched to the physical location where the arc-fault is thought to have been detected. In addition, if an arc-fault is truly present, it may be difficult to isolate the fault in a large array. Therefore, while arc-fault detection can potentially be implemented at the inverter, performing arc-fault detection at the PV string-level may present several advantages. Specifically, arc-fault detection at the PV string level may provide better sensitivity (due to better signal to noise ratios—SNRs), better PV string-level detection isolation, faster onset detection, and automatic/isolated disabling of the PV string(s) upon detection. The added cost to the string equalizers for arc-fault detection may be relatively low, for example when common techniques like bandpass envelope detection are used. Power lost due to ‘false positives’ may be reduced, and the process of determining the location of the fault may be simplified. In the event an arc-fault is detected, the PV string may be disabled, and power may be lost only for the disabled PV string as opposed to the entire array operating from a given inverter.

It should be noted however that the high-frequency signal normally associated with arc-faults may propagate through the array. In other words, the arc-fault signature from one PV string may also be sensed in other PV strings, resulting in the arc-fault being erroneously detected in those other PV strings. Therefore, in one set of embodiments, the string arc-fault detector may be placed at the bottom of the PV string, and a low-pass filter may be included/configured at the top of each PV string. Given the high-frequency nature of arc-fault signatures, a ferrite bead at the top of each PV string may prove sufficient in many embodiments. A string equalizer at the bottom (or top) of a PV string may include arc-fault detection circuitry, and a low-pass filter may be placed at the other end of the PV string. PV String Level Equalizers (SLEs) may also be adapted to perform series resistance measurements, which may combine with arc-fault detection to provide good visibility into existing and incipient arc-faults.

### String Equalizer Architecture

In one set of embodiments, the core component of a string equalizer may be a DC-to-DC (DC-DC) converter. The purpose of the DC-DC converters may be to move power from strong PV strings to weak PV strings as needed, to match the V_{MP}'s of the PV strings that are connected to an inverter on the DC bus. A DC-DC converter may be a two-port system that scales currents and voltages at one port to be presented at the other port. DC-DC converters may be symmetric, in that either port may be the input port, and currents may flow in either direction through the converter. However, the input ports and output ports may share a common reference pin. In a preferred embodiment, DC-DC converters may be connected at the bottoms of strings of PV panels, as shown in FIG. 9. Furthermore, the DC-DC converters may be designed according to the principles described with respect to FIG. 8.

In the PV system architecture 900 shown in FIG. 9, the left port of each DC-DC converter (910 and 912, which may be instances of DC-DC converter 700 in one embodiment) is connected to the bottom of a string of PV panels (902/906 representing a first PV string and 904/908 representing a second PV string, respectively), and the right port is connected to a common return node 916. In one set of embodiments, the common return node may be a ground reference. Each DC-DC converter may also include a common reference pin connected to a ‘string equalizer bus’ 914, which may operate as the channel that the DC-DC converters 910 and 912 use to move power, for example from strong PV strings to weak PV strings. It should be noted that system 900 is exemplary, and alternate embodiments may include additional DC-DC converters, PV panel strings and additional panels in each PV string, arranged according to the principles indicated in FIG. 9.

The DC-DC converters 910/912 may operate as string equalizer modules to collectively regulate the voltage of the string equalizer bus 914 to a fixed voltage, relative to ground. For example, if the converter ports of DC-DC converters 910 and 912 have a dynamic voltage range of 80V, the string equalizer bus may be regulated to the bottom of that range; i.e., −40V, which may allow the DC-DC converters 910 and 912 to move the bottoms of the PV strings up or down by 40V relative to ground (i.e., in an effective range of −40V to +40V). Such voltage adjustments may allow the DC-DC converters 910 and 912 to act as V_{MP} equalizers for the PV strings. In addition to voltage regulation, the DC-DC converters 910 and 912, i.e., the ‘string equalizers’ 910 and 912 may provide MPPT on each individual PV string. That is, each string equalizer (910 and 912, in FIG. 9) may adjust its left-port voltage as needed to maximize the power production of its string of PV panels. Note that adding voltage to a PV string may require adding power, and that subtracting voltage may entail removing power from a PV string. The amount of power required may also depend on the string currents. For example, PV strings with higher current may move more power for a given voltage change than PV strings with lower string current.

It should also be noted that PV strings may have multiple MPPs. To find a global MPP, a string equalizer may first lock onto the first MPP that it finds while sweeping away from ground. The string equalizer may then analyze that operating point to decide whether alternative MPPs are likely to exist. For example, if the V_{MP} is below the string equalizer bus voltage, the string equalizer may be removing power from its PV string, indicating that its PV string is relatively strong, and that higher-power operating points are unlikely to exist for that PV string. However, if the V_{MP} of a string equalizer is above the string equalizer bus voltage, then the string equalizer may be adding power to its PV string, indicating that that string equalizer may be connected to a relatively weak PV string. In that case, it may be more likely that there are impairments in the PV string, and those impairments are causing the true V_{MP} to be at a higher voltage. Therefore, it may be worthwhile to have the string equalizer sweep to higher voltages, looking for better operating points.

It should also be noted that the inverter may continue to perform MPPT at the top of the PV strings. The node at the top of the PV strings, commonly called the ‘DC bus’ (as shown in FIGS. 1-3, for example), may be connected to the PV strings in a ‘combiner box’. The inverter coupled to the DC bus may continue to perform MPPT tracking according to standard operation, in addition to having special operating modes, which may allow the inverter to sweep away from its MPP to look for alternative MPPs to find the true, global MPP. Those modes may continue to operate without being adversely affected by any activity of the string equalizers 910 and 912.

Power may be moved between string equalizers 910 and 912 (for example) through current that may flow on the string equalizer bus 914. The magnitude and direction of the current at any point along string equalizer bus 914 may depend on the relative strengths of PV strings along string equalizer bus 914. If all PV strings coupled to string equalizer bus 914 are equivalent, no current may flow along string equalizer bus 914. However, if some PV strings are stronger on one side of string equalizer bus 914, then currents may flow from the strong side toward the weak side. For example, FIG. 10 provides an example of a solar array system 920, in which one of the PV panels (PV panel 926 in this case) in one of the PV strings is inoperational. As shown in FIG. 10, panel 926 is not providing an output voltage, that is, its output voltage is 0V. All of the other panels (922, 924, and 928, and other panels—not shown—that may be included between the DC Bus the panel 922, and between the DC Bus and panel 924) in the array may be providing 40 W (e.g. by providing 40V @ 1 A at their respective outputs). As noted above, each PV string, and/or the array 920 may overall include more or fewer panels than those shown. As also previously mentioned, the PV panels in the figures (in general) are shown for illustrative purposes, and aren't meant to limit various embodiments to the number of panels, string equalizer buses and/or string equalizer DC-DC converters explicitly shown herein.

To compensate for the inoperational panel 926, the stronger PV string (which includes panels 924 and 928) may transfer 20 W (e.g. 40V @ 0.5 A) of power to the weak PV string (which includes panels 922 and 926), with the aid of string equalizer DC-DC converters 930 and 932. As a result, the voltages across all of the working panels may be equalized to an absolute value of 20V, while keeping the string currents, I_{MP} at a value of 1 A. Thus, panels 922, 926 and 924 may be at 20V each, while panel 928 may be at −20V. In the configuration illustrated in FIG. 10, the string equalizer bus 934 may need to carry high current loads. For example, in an array with eight PV strings, each with an I_{MP} of 8 A, if each PV string of four of the PV strings included one inoperational PV panel, then the remaining four PV strings may have to make up the power difference. If the voltage values were the same as those used in the example shown in FIG. 10, the four strong PV strings may need to supply 4×4=16 A of current. As a result, the string equalizer bus 934 may need to be implemented with a lower-gauge wire at that connection.

Another way of looking at the operation of system 920 described above is as follows. During normal operation, that is, when all panels are operating properly, each panel may be providing an output power of 40 W, e.g. by providing 40V @ 1 A at their respective outputs. Accordingly, panels 922, 926, 924, and 928 may all be providing 40V @ 1 A at their respective outputs. When panel 926 becomes inoperational, the voltage at the left terminal of string equalizer converter 930 (connected to panel 906) changes, which effects a change in the voltage at the right terminal of string equalizer converter 930 (connected to the common return node 916). Since the right terminal of string equalizer converter 932 is also connected to the common return node 916, the voltage at the right terminal of string equalizer converter 932 also changes in response to the voltage change at the right terminal of string equalizer converter 930. In order to maintain the previously established voltage at its terminal coupled to common return node 916, string equalizer converter 932 pulls power from the PV panels (924, 928, etc.) connected to string equalizer converter 932. This results in a voltage of −20V established at the left terminal of string equalizer converter 932, and a voltage of 20V established at the left terminal string equalizer converter 930.

In one set of embodiments, the operating points of the string equalizers (e.g. string equalizers 910/912 and/or 930/932) may be controlled by a sampled-data DSP (digital signal processing) control system, which may be implemented as the DC-DC controller converter shown in FIG. 8. As previously described, controller converter 700 may operate according to two nested control loops. The inner loop may be a voltage regulation loop that runs at a high sampling rate, with a wide bandwidth. This loop may operate faster than the inverter's (e.g. inverter 110) voltage regulation loop, enabling the string equalizers to hold the string equalizer bus voltage fixed, despite attempts by the inverter to move the DC bus voltage. It should be noted that this control loop may not be BIBO (Bounded Input, Bounded Output) stable when more than one module is connected to the string equalizer bus (e.g. string equalizer bus 914 or 934), since the system is under-determined. That is, the operating point for the modules may not be unique, since the modules have the capability to move current between themselves while still maintaining the string equalizer bus voltage.

The string equalizer MPPT control loop may operate outside the string equalizer's voltage-regulation loop, at a relatively slow rate to allow the array voltages and currents to settle in response to probe steps. When a module attempts to move the voltage at the bottom of the PV string, the voltage regulators in the other string equalizers may react to hold the string equalizer bus voltage constant, and in doing so may alter the current flowing in the string equalizer bus. With regards to probe steps, decorrelating equalizer probe steps from changes in irradiance, inverter bus control, and probe operations of other string equalizers may need to be considered. In one set of embodiments, decorrelation may be achieved using Manchester encoding of the probe steps. A pseudo-random bit sequence may be generated in each string equalizer, and modulated by a +1/−1 bit pair. According to the modulation operation, every probe operation may include a step up and step down, and the sequence may be zero mean. If the pseudo-random bit sequences of the string equalizers are mutually uncorrelated, then the probing operations between the string equalizers may also be uncorrelated.

In order to step the voltage at the bottom of the PV strings, string equalizer modules may rely on the cooperation of the other string equalizers in the array. If string impairments vary between PV strings to the extent that some string equalizers move their string-control voltages to a maximum allowed limit, then those string equalizers may be operated to not participate in voltage regulation. To avoid this scenario, string equalizers may have boundaries associated with their MPPT probing such that their probe steps do not hit voltage limits. Although these string equalizers may not be able to move all the way to the PV string's MPP, and thus, may not be able to maximize PV string power production, voltage regulation on the string equalizer bus may remain unimpeded (i.e., voltage regulation may be designated as a higher priority than MPPT). Furthermore, since cooperation between string equalizers in the array is necessary for equalizer MPPT, the string equalizers may not have the capability to compensate for V_{MP} offsets that are common between all PV strings. String equalizers may be operated to compensate only for differences in V_{MP} between PV strings, and the inverter may be operated to compensate for V_{MP} that is common between all PV strings. Accordingly, the MPPT process in the string equalizers may operate truly independently from the MPPT process of the inverter, assuming that the voltage-regulation processes in the string equalizers effectively control the string equalizer bus voltage.

### Idle Operation

A string equalizer system may also feature the capacity to prevent reverse currents from flowing between PV strings when the system is idle. In conventional arrays, reverse currents are sometimes blocked by string blocking diodes, though such diodes add cost and efficiency losses. In various embodiments of the string equalizer system disclosed herein, matching the PV string V_{MP}'s may block reverse currents. In other words, the PV strings may be balanced, eliminating any imbalance between PV strings that could cause reverse-current flow. PV strings are likely to be equalized naturally by the equalization process. That is, PV strings in a PV array are likely to be equalized when the inverter is turned off after the system has converged, and is in steady state. However, two cases merit special consideration. One is start-up before convergence, and the second is handling changes in shading while the array is idle.

The optimization goals may be different for a system in idle state, versus a system in which the inverter is active. For idle state, the goal may be to minimize reverse currents in PV strings. One solution may include specifying the update gains for string equalizers to be higher when the intention is for PV strings to increase voltage in order to minimize reverse currents, than when the intention is for PV strings to maximize power. As a result, string equalizers that are working to minimize reverse currents may ‘override’ string equalizers that seek to maximize power. This implementation may work best when the weak PV strings do not reach a voltage limit, which may, however, happen for PV strings that are heavily impaired. However, the PV strings that source current into weak PV strings may do so by transferring power from other PV strings, and there may be no net current in the array toward the inverter, which may hold true when voltage regulation is operating effectively. Transiently, when the inverter is turned off, there may be a significant current surge from strong PV strings into weak PV strings until voltage regulation settles. That is yet another reason why it is preferable to have a voltage-regulation loop with a wide and fast bandwidth.

Furthermore, even though the string equalizers may share power, their control algorithms may operate largely autonomously (e.g., no control communications may be necessary between the string equalizers), allowing for a very scalable, distributed control system. New PV strings may be potentially added to an array later, in the form of configurable interconnecting modules, without having to reconfigure existing string equalizers or the inverter. However, the maximum possible current on the string equalizer bus may need to be taken into consideration.

### Managing Maximum Currents

One way of reducing the maximum possible currents on the string equalizer bus may include separating the PV strings in an array into groups, each group having its own, independent string equalizer bus. Of course, if the string equalizer bus is not connected between groups, then the groups may not share power, and therefore, V_{MP} matching between the groups may suffer. However, separating PV strings into subgroups may potentially reduce wiring, and thus, reduce costs. In addition, the mismatches may be generally small if each group still contains many PV strings. It may also be possible to add supervisory intelligence to monitor currents on the string equalizer bus, and have that supervisor function/element limit the control ranges of the modules as needed, to limit the string equalizer bus current. The control may not necessarily require fast response times, since the supervisor may impose tight limits on the control ranges, and open up the control range for selected string equalizers when it determines that the changes may not cause the string equalizer bus current to exceed a particular limit.

The same supervisor element may also be used for arc-fault detection. Arc faults generate electrical noise that can permeate an array. With arc-fault detection present at every string equalizer, many string equalizers in an array may see the electrical signature of a particular arc fault. The supervisor may review arc-fault reports from string equalizers in an array, and make a decision about which PV string most likely contains the arc fault, then attempt to disable that PV string.

### Diverting Peak Power to Batteries

Inverters and array wiring in an array may be engineered to allow for maximum expected currents and power levels. In arrays that do not include mechanical trackers that follow the sun, the daily power curve for an array tends to have a parabolic shape (in clear weather). As a result, the array may operate within 10% of its peak power only for a brief time, but nonetheless, the inverter and array wiring may still be engineered to accommodate the peak. An effective way to reduce the capital costs for an array may include simply shedding power near the peak to shave off the power that comes within 10% of the peak. However, this may waste power that could be produced by the array.

An alternative method may be to save some of the power that is being collected during peak times in batteries, and dump the power during low-power times. To reduce capital costs, the saved power may need to be shunted to batteries before it is provided to the combiner box. One possible way to shunt the saved power to batteries may be to connect the string equalizer bus to batteries directly. If the modules are directed to regulate the bus voltage to the battery voltage, then no current may flow into or out of the batteries. If the target bus voltage is set above the battery voltage, the batteries may be charged. If the target bus voltage is set below the battery voltage, the batteries may be discharged.

This mechanism may also be regulated by a supervisor. That is, the current flowing into the batteries may be monitored, and the current flow may be regulated by controlling the target bus voltage. PV string equalization may likely stop functioning when the batteries are being charged or discharged, so it may be desirable for the supervisor to constrain the string equalizer bus voltage to equal to the battery voltage when power production is not near the peak value.

Coexistence with Panel-Level Optimization

Equalized PV strings may coexist with panel-level optimized PV strings in the same array. Panel-level optimized PV strings have a ‘flat’ power curve, over a limited voltage range. Such PV strings produce essentially the same amount of power over that limited range of PV string voltages, which means that panel-level optimized PV strings that are connected in parallel with equalized (or unequalized PV strings) provide power without affecting the inverter's MPPT process for the unoptimized PV strings.

However, panel-level optimized PV strings may source current into neighboring PV strings when the inverter is idle. If the reverse currents are modest, the neighboring PV strings may likely sink the currents without damage, if the existing reverse currents are distributed uniformly between current-sinking PV strings. PV string equalization in the current-sinking PV strings may naturally balance the PV strings, and therefore, eliminate sinking currents.

### Power Failure Bypass and PV String Level Equalizer Redundancy

One disadvantage of distributed electronics is the associated reduction in system reliability. Since distributed electronics typically indicate more electronics, with more potential failure points in the system, distributed-electronics power control can make PV power systems less reliable. SLEs mitigate this problem to some degree, with the inclusion of a bypass failsafe function in the string equalizers, allowing a PV array to continue to produce power (though at a pre-equalization level) even if a string equalizer fails.

For example, should power for proper control and switching operation fail, the switching power core of the string equalizer (e.g. switching power converter 702 in converter controller 700) may fail to terminate the PV strings to the proper negative or ground potential. In this event, it may be possible for large voltages to develop across the terminals of the power core itself. To prevent this effect, a static bypass mechanism may be implemented across the power core terminals. This bypass function may comprise a Normally Closed Relay, or the semiconductor equivalent in the form of a normally ON (depletion mode) FET. Once power for switching and control is available, and switching is confirmed by the control system, the bypass ‘switch’ may be disconnected to allow for equalization. The bypass function may be engaged at any point by the active control system, during equalization for either protection or other power-core bypass functions. A dynamic bypass function may allow for comparative diagnostics across PV strings for improved and enhanced analysis of power loss causes.

In one set of embodiments, in order to further improve the robustness of the SLE system, a bypass may be added not only between the PV strings and ground, but also between the SLEs and the string equalizer bus. This additional bypass may prevent a dead module from affecting the string equalizer bus, and thus allow the remaining working SLEs to operate normally. However, this may not necessarily allow the system to truly maximize power from the remaining PV strings, since the bypassed PV string may still influence the inverter's MPPT.

An alternative approach, therefore, may be to add redundancy. Adding redundancy increases reliability in electronic systems, for example by automatically deploying redundant electronic components in the event of a hardware failure, making the system less dependent on particular components. If a hardware failure is detected, the backup system may be engaged, allowing the system to continue to operate at peak performance, and reducing the urgency for system repair. String-level equalization naturally lends itself to redundant deployment. The failsafe bypass function may potentially allow string equalizers to be connected in series. For example, when a string equalizer is held in bypass, it may be transparently added in series with an existing equalizer.

The simple series addition may work directly if the equalizer-bus bypass is also present in the string equalizers. Normal operation of the string equalizer bus may not be affected if an SLE is on standby. In embodiments where the equalizer-bus bypass is not present in the SLEs, redundant string equalizer buses may be implemented. Each PV string may have two SLEs in series. Each of those two SLEs may be connected to a different string equalizer bus. One string equalizer bus may be unused (on standby), as a backup. If an SLE on the primary string equalizer bus fails, all of the SLEs on that bus may be bypassed, and the secondary SLEs connected to the backup string equalizer bus may be enabled.

### Algorithms

Considering a two port bidirectional switching power converter (such as converter controller 700), power may be moved from either port to the other port by control of the duty cycle as a function of the external operating points of the ports. For example, in case of a simple buck converter where Vₒᵤₜ<Vᵢₙ, for a given duty cycle D (normalized to 0<=D<=1), Vₒᵤₜ is proportional to Vᵢₙ*D. Considering a stable operating condition and a change to the duty cycle, it is possible to evaluate how the power flow would be affected. For stable operation with a duty cycle Ds, with the duty cycle incremented to Di (where Di=Ds+delta), the Ratio of Vₒᵤₜ<Vᵢₙ may increase, and the system may attempt to raise Vₒᵤₜ from its current state (supposing Vᵢₙ is relatively fixed). Presuming Vₒᵤₜ is held in place by a load or other external control system, power may be moved from the input port to the output port in order to effect a change in Vₒᵤₜ, or in practice, current may flow to the output port, and the converter may operate as a power ‘source’. Presuming that the power is used (i.e. output current is sunk) somewhere else in the system, Vₒᵤₜ may not move as Iₒᵤₜ may increase instead. In this manner, a ‘bus’ may be created through which multiple converters may exchange power by attempting to regulate the bus voltage, either sinking current from the bus or sourcing current into the bus according to their relative control system requirements.

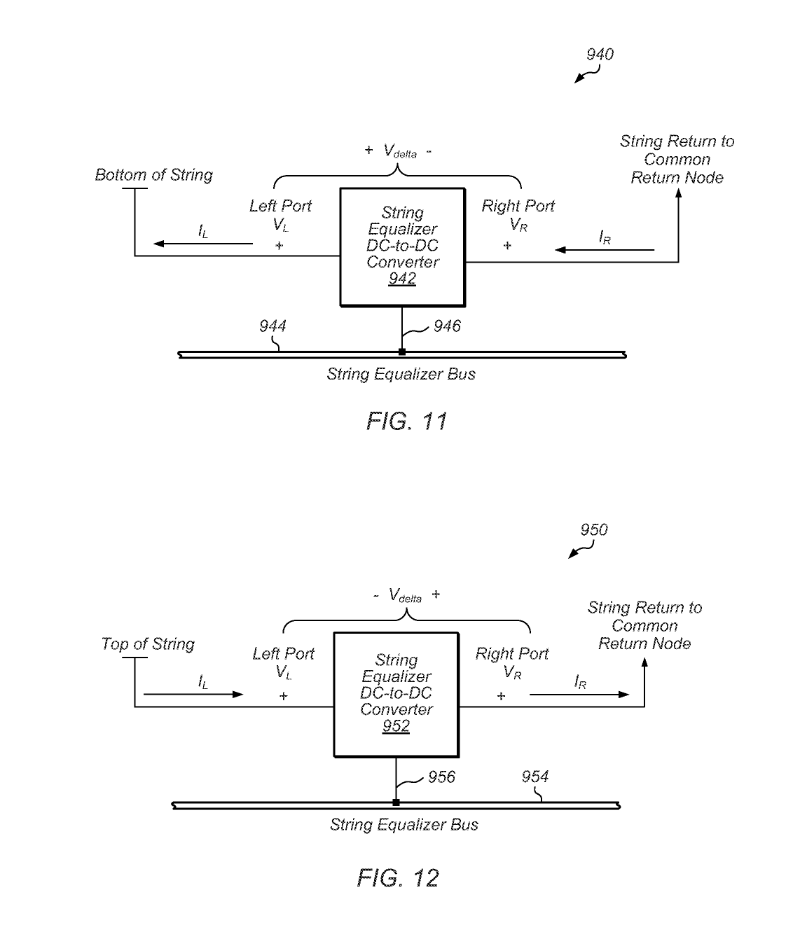

As shown in one embodiment of a configuration 940 in FIG. 11, the string equalizer bus 944 may be biased at a sufficiently negative voltage. The left-hand port of converter 942 may be connected to the bottom of the PV string referenced to the string equalizer bus 944, and may utilize an MPP tracking algorithm to dynamically determine the best voltage for maximizing power of the PV string within the compliance range of converter 942. The right-hand port of converter 942 may be connected to the PV string common return node (such as node 916 in FIG. 9, for example) referenced to the string equalizer bus 944, and may utilize a simple voltage regulation algorithm to maintain the string equalizer bus 944 at the determined negative value. Since Power=V*I for each port, and the power at both ports may be the same (not considering efficiency losses), for V_{delta}>0, V_{L}>V_{R}, therefore I_{R}>I_{L}. Thus, additional current may flow out of the string equalizer bus terminal 946, creating the voltage difference V_{delta} with the polarities as show in FIG. 11. This may be accomplished over the regulated string equalizer bus 944, since V_{R} may need to increase in order to push current out of the reference bus terminal 946. As all of the units attached to the string equalizer bus 944 may also regulate the string equalizer bus voltage, the other units attached to the string equalizer bus may try to oppose any change in the reference bus voltage, and may sink the current from the string equalizer bus 944 as required, to satisfy the regulation requirements. This may in turn force the V_{L} voltages for those units to decrease relative to their V_{R} voltages, to sink the current. In effect, the power conversion unit 942 may serve as a ΔV to ΔI transposition function using the string equalizer bus 944 to transport current, to balance voltages at the various PV strings.

Accordingly, each unit (e.g. converter 942, which may be an instance of a converter such as converter controller 700) may either supply current to string equalizer bus 944, or extract current from string equalizer bus 944 in accordance with the associated MPPT port regulation pressure, to lengthen or shorten the PV string—in the voltage domain—to optimize power for that PV string. A perfect array of balanced PV strings may be expected to exhibit zero current over the string equalizer bus 944, with low level currents present only to the extent of the tolerances of measurements within the units themselves. Furthermore, for a distribution of voltage-mismatched PV strings, a distribution with a zero net balance may be expected for current contributions to string equalizer bus 944, and current extractions from string equalizer bus 944.

The topology shown in FIG. 11 may also be inverted for application into the ‘top’, positive voltage string return line, as shown in FIG. 12. There may be some applications, such as positive grounded PV string configurations, which may lead to the configuration shown in FIG. 12 being preferred to the configuration shown in FIG. 11. The left-hand port of converter 952 may be connected to the top of the PV string referenced to the string equalizer bus 954, and may utilize an MPP tracking algorithm to dynamically determine the best voltage for maximizing power of the PV string within the compliance range of converter 952. The right-hand port of converter 952 may be connected to the PV string common return node referenced to the string equalizer bus 954, and may utilize a simple voltage regulation algorithm to maintain the string equalizer bus 954 at the determined negative value. Again, Power=V*I for each port, and the power at both ports may be the same (not considering efficiency losses), for V_{delta}>0, V_{R}>V_{L}, therefore I_{L}>I_{R}. Thus, additional current may flow out of the string equalizer bus terminal 956, creating the voltage difference V_{delta} with the polarities as show in FIG. 11. This may be accomplished over the regulated string equalizer bus 954, since V_{L} may need to increase in order to push current out of the reference bus terminal 956. As all of the units attached to the string equalizer bus 954 may also regulate the string equalizer bus voltage, the other units attached to the bus may try to oppose any change in the string equalizer bus voltage, and may sink the current from the string equalizer bus 954 as required, to satisfy the regulation requirements, similar to the example shown in FIG. 11 with respect to string equalizer bus 944. This may in turn force the V_{R} voltages for those units to decrease relative to their V_{L} voltages, to sink the current. In effect, the power conversion unit 952 may serve as a ΔV to ΔI transposition function using the string equalizer bus 954 to transport current, to balance voltages at the various PV strings.

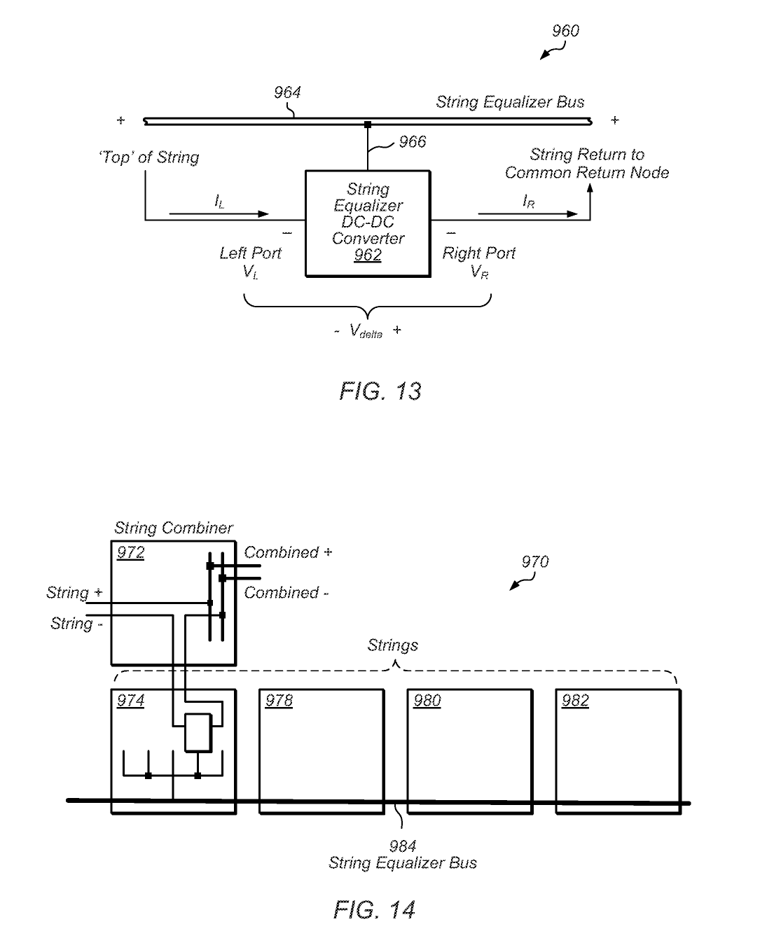

An alternative topology for ‘Top of String’ applications may be a complete inversion of the power core utilizing a mirrored design of the “Bottom of String” topology, as shown in FIG. 13. Analysis for FIG. 13 may be performed similar to the analyses provided above for FIGS. 11 and 12, respectively.

### Array-Level Architectures

Each of the power conversion units described herein may be attached to a single string of PV panels (e.g. solar panels). Several strings of PV panels may be brought into a fused and switched bus-bar unit in a “PV string combiner box”. The PV string equalization system may either be built directly into the PV string combiner box, or placed more conveniently into a near mounted ‘equalization box’ enclosure with a number of equalization units matching the number of PV strings in the neighboring combiner box. Each of the equalization units may then share the local reference bus wiring via a simple backplane or other convenient and reliable mechanism.

Sharing the reference bus within a single combiner unit having at least several PV strings may be sufficient for appropriate power equalization across the array. However, if the mean relative length of the PV strings within a given combiner is mismatched relative to the mean relative length of the PV strings in another combiner, extending the reference bus connection between the combiner equalization units may provide the best equalization. Since the total power within a combiner may be high, the differences in relative power equalization may also be high, and thus the potential currents between combiner units may be many multiples of the current within a given combiner unit backplane, even if this may not be expected in a relatively random distribution.

Given this condition the current handling of the inter-combiner reference bus wiring may be up-sized, or a current-limiting algorithm process may be applied to the inter-combiner reference bus connections, to prevent excess current paths—or a combination of both. FIG. 14 shows one embodiment of a solar array 970 with PV strings 974-982, featuring “Bottom of String” wiring connectivity (as partially detailed inside PV string 974) connecting to reference bus 984, with the “Top of String” wired straight through the PV string combiner 972 as shown. The embodiment shown in FIG. 14 may easily be extended to incorporate a “Top of String” topology, or both topologies together. It may be acceptable, as well as potentially advantageous, to incorporate PV string equalization units into both the top and bottom of PV strings simultaneously. Use of such double-terminated equalization may allow for twice the adaptation range.

### Series Resistance

Series resistance is a parameter that may be useful in assessing the health of solar PV panels. Series resistance is a parasitic component associated with the electrical response of a PV panel. The lower the series resistance, the higher the panel efficiency, since power is lost when current flows through series resistance. The series resistance of a panel may change with respect to time, typically increasing due to corrosion and micro-fractures in conductors. Not only does this phenomenon reduce efficiency, the increases in series resistance may be localized, and thus create hot spots that can affect system reliability. A conventional means for measuring the series resistance of a panel is to measure the slope of the I/V curve near V_{OC}. This slope is largely independent of irradiance and temperature. It may be advantageous to measure the series resistance not only at a given panel, but also for entire strings of PV panels, especially within a string-equalizer system. However, moving PV string voltages all the way to V_{OC} through normal PV string equalization adjustments using PV string equalizers may be a challenge, since PV string-voltage adjustments may be only about ±10%, while V_{oc} may typically change (move) 20% or more from V_{MP}.

In one set of embodiments, the inverter (e.g. inverter 110 shown in FIGS. 1-3) may be turned off for the series-resistance measurement. The string equalizer mechanism may be deliberately used to then cause currents to flow between PV strings. These currents may be used to probe the responses of PV strings in the vicinity of V_{OC}. Indeed, the V_{OC} of a PV string may be determined/obtained by seeking the voltage at or around which the PV string current switches from a positive current to a negative current. By observing how the voltage and current change in the vicinity of V_{OC}, an accurate estimate of the slope of the I/V curve may be generated.

When the inverter is first turned off, some current may still flow between PV strings if snapped diodes were present during power production. Since there may not be enough current flowing to hold the diodes snapped when the inverter is turned off, as the PV string equalizer adapts to eliminate reverse currents, snapped diodes may unsnap. The string response may be very non-linear near the region where the diode turn-on occurs. As a result, it may be advantageous to measure the slope using negative currents only, as close to V_{OC} as possible. To facilitate the control function, a supervisory function may be adapted to select PV strings, and to control the sweep function. In one set of embodiments, all of the PV strings may be tested in parallel, by first designating each PV string as either an “even” PV string or an “odd” PV string, subsequently moving all even PV strings up in voltage at the same time that all odd PV strings are moved down in voltage.

### Status Light Emitting Diodes (LEDs) in the Combiner Box

One disadvantage of solar PV systems is the difficulty in providing visually discernible performance. The inverter display may provide information usable to determine the power production of an array, but any finer-grained view typically requires special equipment that is not nominally present at an array. Finer grain information may be helpful in debugging an array. For example, it may be difficult to tell how the array is wired, and, in the case of some arrays, no wiring map may be available. In these cases the wiring of the array may have to be reverse-engineered before repairs can be performed on the array, and this reverse-engineering may be accelerated by the availability of fine grain performance information. It may also be difficult to ascertain if repair and cleaning efforts are helpful or sufficient without the availability of fine grain, direct performance information. This is equally true when the defect is in a panel, in the wiring, or in a string equalizer. It may be useful, for example, to have direct information or knowledge of the status of a new, replacement string equalizer to determine whether the new string equalizer is functioning properly. It may further be useful to have fine grain information that is not dependent on the functionality or status of uplink communications equipment.

In one set of embodiments, LEDs may be added/configured in the smart combiner box (e.g. PV string combiner 972 shown in FIG. 14). Currently, there are no smart combiner boxes that feature LED status information. Existing systems require that data from the combiner box be transmitted (over wireless uplink, for example) to an external system for translation and display. SLE presents a valuable opportunity to present visual PV string-level performance information at the combiner box. Each PV string equalizer may possess information about how its PV string is performing relative to the other PV strings attached to a particular string equalizer bus. That information may be presented directly via LEDs. For example, each string equalizer may include an RGB LED to indicate the relative differential voltage at the bottom of each PV string. In one set of embodiments, a mapping may be established between the Red LED and PV strings that require added voltage, Green LED and PV strings that are neutral, and Blue LED for PV strings that are providing power to weak PV strings. Other colors may be obtained by multiplexing the LEDs, for example via PWM.

In addition to providing differential voltages, PV strings may also provide different currents, due to different panel orientations between PV strings, for example. However, a string equalizer may not be autonomously aware of what its current is relative to its neighboring PV strings. Thus, in some embodiments, communication may be established between string equalizers (e.g. string equalizers 910 and 912 shown in FIG. 9, and string equalizers 930 and 934 shown in FIG. 10), and this communication may be provided by an external supervisory system. However, if string current information is available, the relative string currents may be indicated by LED color, with a separate LED associated with different current types. For example, weak PV strings may be indicated by a specified color (e.g. Red), nominal PV strings may be indicated by another specified color (e.g. Green), and strong PV strings may be indicated by yet another specified color (e.g. Blue). This may yield a consistent paradigm, with one specified color (e.g. Red) corresponding to ‘weak’, another specified color (e.g. Blue) corresponding to ‘strong’, and another specified color (e.g. Green) corresponding to ‘nominal’.

The LEDs may also indicate whether a string equalizer is active, or in bypass mode, for example by blinking when a string equalizer is in bypass mode. Overall, this may provide a system where the health and status of string equalizers and their PV strings may be determined, to first order, at a glance. It may not be possible to tell if a combiner box is actively making power, however. Accordingly, another isolated LED may be added to provide an indication of total PV string current, which would be indicative of the strength of the total current flowing from the combiner box toward the inverter.

Numerous variations and modifications will become apparent to those skilled in the art once the above disclosure is fully appreciated. Note the section headings used herein are for organizational purposes only, and are not meant to limit the descriptions provided herein. Numerical values throughout have been provided as examples, and are not meant to limit the descriptions provided herein.

We claim:

1. A photovoltaic (PV) array system comprising:
a plurality of PV strings, each respective PV string of the plurality of PV strings comprising a respective plurality of PV panels coupled in series;
a plurality of string equalizer modules, wherein each respective string equalizer module of the plurality of string equalizer modules is coupled at one end of a corresponding respective PV string of the plurality of PV strings, wherein each respective string equalizer module is configured to equalize a maximum power-point voltage (V_{MP}) of its corresponding respective PV string before the plurality of PV strings combine to produce a single, composite DC bus voltage on a DC bus.

2. The PV array system of claim 1, wherein at least one of the plurality of string equalizer modules is further configured to generate a respective adaptive string equalizer output voltage to tune a respective PV string voltage of its corresponding respective PV string to have its V_{MP} match respective V_{MP}'s of other PV strings of the plurality of PV strings.

3. The PV array system of claim 1, wherein the plurality of PV strings are configured to have lower power PV strings sink power from higher power PV strings, to equalize the V_{MP} of each corresponding respective PV string of the plurality of PV strings.

4. The PV array system of claim 1, wherein power required by one or more respective PV strings of the plurality of PV strings for equalizing their respective V_{MP}'s is provided by one or more power sources other than the plurality of PV strings.

5. The PV array system of claim 4, wherein the one or more power sources comprise at least one of:
the DC bus voltage;
an inverter coupled to the DC bus;
an external power supply;
an external power storage device; and
a battery.

6. The PV array system of claim 1, wherein the plurality of PV strings are configured to have one or more of the plurality of PV strings move power from the one or more of the plurality of PV strings to a power storage medium.

7. The PV array system of claim 1, wherein at least one respective string equalizer module of the plurality of string equalizer modules comprises a DC-to-DC buck/boost converter configured to divert power from higher power PV strings of the plurality of PV strings to lower power PV strings of the plurality of PV strings.

8. The PV array system of claim 1, wherein the plurality of string equalizer modules are configured together in a string equalizer combiner module placed at a common junction where respective ends of the plurality of PV strings intersect.

9. A photovoltaic (PV) array system comprising:
a plurality of PV strings, each respective PV string of the plurality of PV strings comprising a respective plurality of PV panels coupled in series;
a plurality of string equalizer modules, wherein each respective string equalizer module of the plurality of string equalizer modules comprises:
a first terminal coupled to a PV panel configured at one end of a corresponding respective PV string of the plurality of PV strings;
a second terminal coupled to a common return node; and
a third terminal coupled to a string equalizer bus;
wherein each respective string equalizer module of the plurality of string equalizer modules is configured to change a respective voltage at its first terminal in a direction opposite of a change of a first voltage at the first terminal of another one of the plurality of string equalizers, in response to the change of the first voltage.

10. The PV array system of claim 9, wherein each string equalizer module of the plurality of string equalizer modules comprises:
a maximum power point tracking (MPPT) control loop comprising the first terminal of the string equalizer module; and
a voltage regulation loop comprising the second terminal of the string equalizer module.

11. The PV array system of claim 10, wherein the MPPT control loop operates outside the voltage-regulation loop at a relatively slow rate, to allow voltages and currents in the PV array system to settle in response to probe steps applied as part of MPPT performed by the MPPT control loop.

12. The PV array system of claim 9, wherein the plurality of string equalizer modules are configured to compensate for differences in respective maximum power point (MPP) voltages between the plurality of PV strings.

13. The PV array system of claim 9, wherein a respective PV panel at one end of each PV string of the plurality of PV strings is coupled to a common DC voltage bus.

14. The PV array system of claim 13, further comprising an inverter coupled to the common DC voltage bus to generate an AC voltage from a DC voltage developed on the DC voltage bus, and configured to perform MPPT on the DC voltage bus.

15. The PV array system of claim 14, wherein each string equalizer module of the plurality of string equalizer modules is configured to perform MPPT for its corresponding respective PV string independently from the MPPT performed by the inverter.

16. A photovoltaic (PV) string equalizer module comprising:
a first terminal configured to couple in series with a corresponding respective PV string of a plurality of PV strings, the corresponding respective PV string comprising a respective plurality of PV panels coupled in series; and
first circuitry configured to equalize a maximum power-point voltage (V_{MP}) of the corresponding respective PV string before the plurality of PV strings combine to produce a single, composite DC bus voltage on a DC bus.

17. The PV string equalizer of claim 16, wherein the first circuitry is further configured to generate a respective adaptive string equalizer output voltage at the first terminal to tune a respective PV string voltage of the corresponding respective PV string to have the V_{MP} of the corresponding respective PV string match respective V_{MP}'s of other PV strings of the plurality of PV strings.

18. The PV string equalizer of claim 16, wherein the first circuitry is further configured to sink or source power from/to other PV strings of the plurality of PV strings, to equalize the V_{MP} of each corresponding respective PV string of the plurality of PV strings.

19. The PV string equalizer of claim 16, wherein the first circuitry comprises a DC-to-DC buck/boost converter configured to:
sink power from the other PV strings when power provided by the corresponding respective PV string is lower than power provided by each of the other PV strings; and
source power to any one or more of the other PV strings that provide lower power than the power provided by the corresponding respective PV string.

20. The PV string equalizer of claim 16, wherein power required by the PV string equalizer for equalizing its respective V_{MP} is provided by one or more of:
one or more power sources that do not comprise the plurality of PV strings; or
power storage media.
